(19) United States
(12) Patent Application Publication
(10) Pub. No.: US 2005/0120066 A1
(43) Pub. Date: Jun. 2, 2005

(54) Interpolator, interpolation method, and signal processing circuit

(76) Inventor: Orimitsu Serizawa, Gyouda-shi (JP)

Correspondence Address: OSHA & MAY L.L.P., 1221 MCKINNEY STREET, SUITE 2800, HOUSTON, TX, 77010, US

(21) Appl. No.: 10/977,558

(22) Filed: Oct. 29, 2004

(30) Foreign Application Priority Data
Oct. 31, 2003 (JP) 2003-373594

(51) Int. Cl. G06F 7/38

(52) U.S. Cl. 708/290

(57) ABSTRACT

An interpolator interpolates a digital signal obtained by digitally sampling an analog signal. The interpolator comprises a register which receives the digital signal at a plurality of taps and generates tap outputs from a plurality of the taps, a multiplier which multiplies each of the tap outputs by a coefficient defined to impart a capability of a bandpass filter which passes a signal in a predetermined frequency range to the tap outputs, and an adder which sums outputs from the multiplier.

The disclosure of Japanese Patent Application No. 2003-373594 including specification, claims, drawings and abstract is incorporated herein by reference in its entirety.

### BACKGROUND OF THE INVENTION

1. Field of the Invention

The present invention relates to an interpolator for interpolating bit points in an input signal sampled in digital signal processing, and relates to an interpolation method and a signal processing circuit.

2. Description of the Related Art

In a digital data receiving system, a received signal is sampled in an analog/digital (A/D) converter using a clock which is usually in synchronism with a symbol of the received signal to decode digital data. Asynchronous sampling is also conventional in which sampling is executed using an asynchronous clock. In asynchronous sampling, an interpolator estimates and calculates data on symbol points between samples from sample point data. According to interpolator concepts, interpolation is completed by processing a signal sampled at a certain frequency by zero interpolation upsampling at a higher frequency, then removing a resultant unnecessary image signal through a lowpass filter (LPF), and then resampling the signal in a series of downsampling operations for reduction (refer to Japanese Patent Laid-Open Publication No. 2003-244258, and No. Hei 7-297680).

However, in a reproduction channel of a digital system, such as, for example, a digital video camera (DVC), a signal read by a head is amplified in a head amplifier, and the signal output from the head amplifier is equalized to a waveform, such as a Class-4 partial response (PR4) waveform, in order to remove waveform distortion from a signal to be reproduced. Although no direct-current (DC) component is contained in necessary signal components for PR4 properties, a DC offset component is actually added to a signal in the head amplifier, A/D converter, and other devices in a real system. To remove such a DC offset component, it is necessary to connect a coupling condenser before the A/D converter and insert a DC offset cancellation circuit after the A/D converter, which increases the number of outboard components and makes the circuit complicated, with resulting expansion of circuit scale. It should be noted that the above-described lowpass filter cannot eliminate the DC offset component.

### SUMMARY OF THE INVENTION

The present invention provides an interpolator having a function capable of removing a DC offset component.

In one aspect of the present invention, an interpolator for interpolating a digital signal obtained by digitally sampling an analog signal comprises a register which receives the digital signal at a plurality of taps and generates tap outputs from a plurality of the taps, a multiplier for multiplying each of the tap outputs by a coefficient defined to impart a capability of a bandpass filter which passes a signal in a predetermined frequency range to the tap outputs, and an adder for summing outputs from the multiplier.

In another aspect, the present invention provides an interpolation method for interpolating a digital signal obtained by digitally sampling an analog signal, the interpolation method comprising receiving the digital signal at a plurality of taps and generating tap outputs from a plurality of the taps, multiplying each of the tap outputs by a coefficient defined to impart a capability of a bandpass filter which passes a signal in a predetermined frequency range to the tap output, and summing the multiplied outputs.

In still another aspect, the present invention provides a signal processing circuit comprising an interpolator for interpolating a digital signal obtained by digitally sampling an analog signal, the interpolator including a register which receives the digital signal at a plurality of taps and generates tap outputs from a plurality of the taps, a multiplier for multiplying each of the tap outputs by a coefficient defined to impart a capability of a bandpass filter which passes a signal in a predetermined frequency range to the tap outputs, and an adder for summing outputs from the multiplier.

With the interpolator according to the present invention, a DC offset component can be removed without provision of a circuit, such as a coupling condenser, a DC offset cancellation circuit, etc.

### BRIEF DESCRIPTION OF THE DRAWINGS

One embodiment of the present invention will be described in detail based on the following figures, wherein:

FIG. 1 is a schematic diagram showing an example configuration of a signal processing circuit according to an embodiment of this invention;

FIG. 2 is a schematic diagram showing an example configuration of an interpolator according to an embodiment of this invention;

FIG. 3 is a graph showing frequency characteristics of a signal processed in the interpolator according to the embodiment of this invention using tap coefficients listed in Table 1;

FIG. 4 is a graph showing frequency characteristics of a signal processed in the interpolator according to the embodiment of this invention using tap coefficients listed in Table 2;

FIG. 5 is a graph showing frequency characteristics of a signal processed in the interpolator according to the embodiment of this invention using tap coefficients listed in Table 3; and

FIG. 6 is a graph showing frequency characteristics of a signal processed in a conventional interpolator having a LPF capability.

### DESCRIPTION OF THE PREFERRED EMBODIMENT

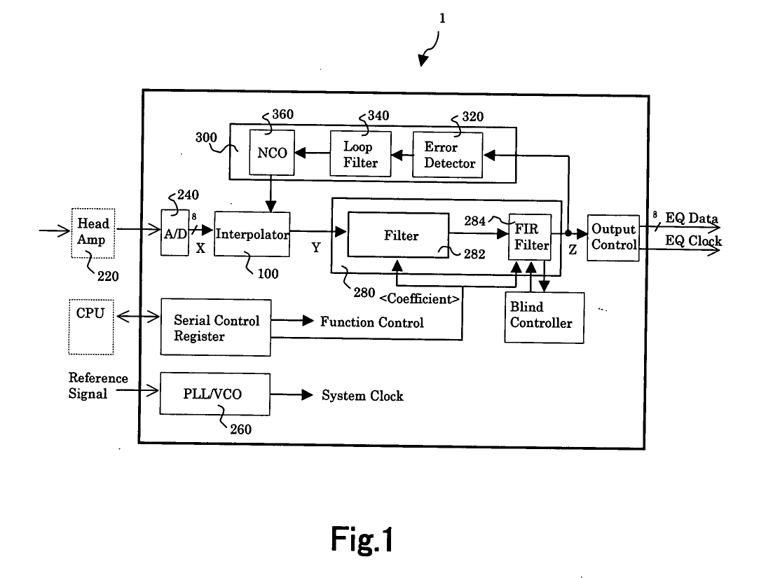

Referring to drawings, an embodiment of this invention will be described below. FIG. 1 shows an example configuration of a signal processing circuit 1 including an interpolator according to this embodiment. An analog signal read by, for example, a head of a DVC is amplified by a head amplifier 220, and the amplified analog signal is digitally sampled at a sampling frequency fs in an A/D converter 240 and then output as a data sample X. A clock of the sampling frequency fs is generated from a phase locked loop (PLL)/voltage controlled oscillator (VCO) 260.

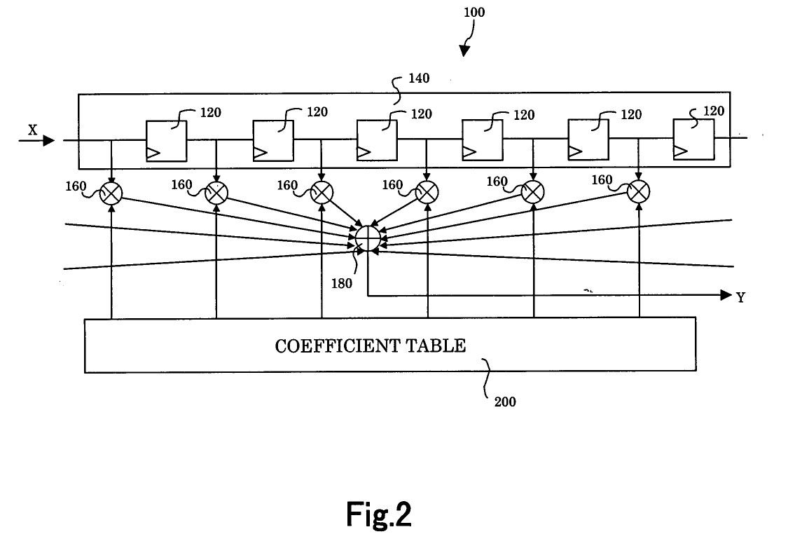

An interpolator 100 estimates and interpolates a bit point from data asynchronously sampled by digital signal processing. The interpolator 100 comprises, for example, a shift register 140 including taps 120, multipliers 160, and an adder 180 as shown in FIG. 2. The shift register 140 receives the data sample X in succession, and each of the multipliers 160 multiplies an output from one of the taps 120 by a tap coefficient output from a coefficient table 200. The adder 180 sums all products obtained from the multipliers 160 to generate an output data sample Y. Here, it should be noted that the tap coefficient may be variable, and may be set to any value according to various characteristics of a signal. In particular, in the DVC, because the output from the head amplifier is equalized to a waveform having PR4 equalization properties or the like, no direct-current (DC) component is contained in necessary signal components. Therefore, by eliminating or suppressing a direct-current amplitude gain, the interpolator 100 can be provided with a capability of a bandpass filter (BPF) which passes a signal in a predetermined frequency range rather than a capability of a lowpass filter (LPF) in related arts. In this manner, the interpolator 100 becomes capable of removing the DC component.

In this embodiment, the tap coefficient is defined to give the capability of the BPF to the interpolator 100. Sample values set to the tap coefficients when thirty two points, for example, are interpolated using ten taps are listed in Tables 1, 2, and 3 below. In Tables 1, 2, and 3, each vertical column represents a tap number (in this case, ten taps are arranged in ten columns), and each horizontal row represents a location to be interpolated (in this case, thirty two points are picked up as locations to be interpolated between forth and fifth taps and numeral 0 is given to a point closest to the fifth tap and numeral 31 is given to a point closest to the fourth tap).

TABLE 1

| | | Tap Number | | | | | | | | | |
|---|---|---|---|---|---|---|---|---|---|---|---|
| | | 0 | 1 | 2 | 3 | 4 | 5 | 6 | 7 | 8 | 9 |
| Location of | 0 | 0 | −1 | 2 | −10 | 11 | 47 | 9 | −9 | 2 | −1 |
| Interpolation | 1 | −1 | −1 | 2 | −10 | 12 | 47 | 8 | −9 | 2 | −1 |
| | 2 | −1 | −1 | 2 | −10 | 14 | 47 | 6 | −9 | 2 | −2 |
| | 3 | −1 | −1 | 2 | −10 | 15 | 47 | 5 | −8 | 2 | −2 |
| | 4 | −1 | −1 | 1 | −11 | 17 | 46 | 3 | −8 | 2 | −2 |
| | 5 | −1 | −1 | 1 | −11 | 19 | 46 | 2 | −7 | 2 | −2 |
| | 6 | −1 | −1 | 1 | −11 | 20 | 45 | 1 | −7 | 2 | −2 |
| | 7 | −1 | −1 | 1 | −11 | 22 | 44 | 0 | −6 | 2 | −2 |
| | 8 | −1 | 0 | 0 | −11 | 24 | 44 | −2 | −6 | 2 | −2 |
| | 9 | −1 | 0 | 0 | −11 | 25 | 43 | −3 | −6 | 2 | −2 |
| | 10 | −1 | 0 | 0 | −10 | 27 | 42 | −4 | −5 | 2 | −2 |
| | 11 | −1 | 0 | −1 | −10 | 29 | 41 | −5 | −5 | 2 | −2 |
| | 12 | −1 | 0 | −1 | −10 | 30 | 40 | −6 | −4 | 1 | −2 |
| | 13 | −1 | 0 | −1 | −9 | 32 | 38 | −6 | −4 | 1 | −2 |
| | 14 | −1 | 1 | −2 | −9 | 33 | 37 | −7 | −3 | 1 | −2 |
| | 15 | −1 | 1 | −2 | −8 | 35 | 36 | −8 | −3 | 1 | −2 |
| | 16 | −2 | 1 | −3 | −8 | 36 | 35 | −8 | −2 | 1 | −1 |
| | 17 | −2 | 1 | −3 | −7 | 37 | 33 | −9 | −2 | 1 | −1 |
| | 18 | −2 | 1 | −4 | −6 | 38 | 32 | −9 | −1 | 0 | −1 |
| | 19 | −2 | 1 | −4 | −6 | 40 | 30 | −10 | −1 | 0 | −1 |
| | 20 | −2 | 2 | −5 | −5 | 41 | 29 | −10 | −1 | 0 | −1 |
| | 21 | −2 | 2 | −5 | −4 | 42 | 27 | −10 | 0 | 0 | −1 |
| | 22 | −2 | 2 | −6 | −3 | 43 | 25 | −11 | 0 | 0 | −1 |
| | 23 | −2 | 2 | −6 | −2 | 44 | 24 | −11 | 0 | 0 | −1 |
| | 24 | −2 | 2 | −6 | 0 | 44 | 22 | −11 | 1 | −1 | −1 |
| | 25 | −2 | 2 | −7 | 1 | 45 | 20 | −11 | 1 | −1 | −1 |
| | 26 | −2 | 2 | −7 | 2 | 46 | 19 | −11 | 1 | −1 | −1 |
| | 27 | −2 | 2 | −8 | 3 | 46 | 17 | −11 | 1 | −1 | −1 |
| | 28 | −2 | 2 | −8 | 5 | 47 | 15 | −10 | 2 | −1 | −1 |
| | 29 | −2 | 2 | −9 | 6 | 47 | 14 | −10 | 2 | −1 | −1 |
| | 30 | −1 | 2 | −9 | 8 | 47 | 12 | −10 | 2 | −1 | −1 |
| | 31 | −1 | 2 | −9 | 9 | 47 | 11 | −10 | 2 | −1 | 0 |

TABLE 2

| | | Tap Number | | | | | | | | | |
|---|---|---|---|---|---|---|---|---|---|---|---|
| | | 0 | 1 | 2 | 3 | 4 | 5 | 6 | 7 | 8 | 9 |
| Location | 0 | −1 | −3 | 0 | −15 | 3 | 39 | 1 | −15 | 0 | −3 |
| of | 1 | −1 | −3 | −1 | −16 | 4 | 39 | 0 | −14 | 0 | −3 |
| Inter- | 2 | −1 | −3 | −1 | −16 | 6 | 39 | −2 | −14 | 0 | −3 |
| polation | 3 | −1 | −2 | −1 | −16 | 8 | 39 | −3 | −13 | 0 | −3 |
| | 4 | −1 | −2 | −1 | −17 | 9 | 38 | −4 | −13 | 0 | −3 |
| | 5 | −1 | −2 | −2 | −17 | 11 | 38 | −6 | −12 | 0 | −3 |
| | 6 | −1 | −2 | −2 | −17 | 12 | 37 | −7 | −12 | 0 | −3 |
| | 7 | −1 | −2 | −2 | −17 | 14 | 37 | −8 | −11 | 0 | −3 |
| | 8 | −1 | −2 | −3 | −17 | 16 | 36 | −9 | −11 | 0 | −3 |
| | 9 | −2 | −2 | −3 | −17 | 17 | 35 | −10 | −10 | 0 | −3 |
| | 10 | −2 | −2 | −3 | −17 | 19 | 34 | −11 | −9 | 0 | −3 |
| | 11 | −2 | −2 | −4 | −17 | 21 | 33 | −12 | −9 | 0 | −3 |
| | 12 | −2 | −1 | −4 | −17 | 22 | 32 | −13 | −8 | 0 | −3 |
| | 13 | −2 | −1 | −5 | −16 | 24 | 31 | −14 | −8 | −1 | −2 |
| | 14 | −2 | −1 | −5 | −16 | 25 | 29 | −14 | −7 | −1 | −2 |
| | 15 | −2 | −1 | −6 | −15 | 27 | 28 | −15 | −6 | −1 | −2 |
| | 16 | −2 | −1 | −6 | −15 | 28 | 27 | −15 | −6 | −1 | −2 |
| | 17 | −2 | −1 | −7 | −14 | 29 | 25 | −16 | −5 | −1 | −2 |
| | 18 | −2 | −1 | −8 | −14 | 31 | 24 | −16 | −5 | −1 | −2 |
| | 19 | −3 | 0 | −8 | −13 | 32 | 22 | −17 | −4 | −1 | −2 |
| | 20 | −3 | 0 | −9 | −12 | 33 | 21 | −17 | −4 | −2 | −2 |
| | 21 | −3 | 0 | −9 | −11 | 34 | 19 | −17 | −3 | −2 | −2 |
| | 22 | −3 | 0 | −10 | −10 | 35 | 17 | −17 | −3 | −2 | −2 |
| | 23 | −3 | 0 | −11 | −9 | 36 | 16 | −17 | −3 | −2 | −1 |
| | 24 | −3 | 0 | −11 | −8 | 37 | 14 | −17 | −2 | −2 | −1 |
| | 25 | −3 | 0 | −12 | −7 | 37 | 12 | −17 | −2 | −2 | −1 |
| | 26 | −3 | 0 | −12 | −6 | 38 | 11 | −17 | −2 | −2 | −1 |
| | 27 | −3 | 0 | −13 | −4 | 38 | 9 | −17 | −1 | −2 | −1 |
| | 28 | −3 | 0 | −13 | −3 | 39 | 8 | −16 | −1 | −2 | −1 |
| | 29 | −3 | 0 | −14 | −2 | 39 | 6 | −16 | −1 | −3 | −1 |
| | 30 | −3 | 0 | −14 | 0 | 39 | 4 | −16 | −1 | −3 | −1 |
| | 31 | −3 | 0 | −15 | 1 | 39 | 3 | −15 | 0 | −3 | −1 |

TABLE 3

| | | Tap Number | | | | | | | | | |
|---|---|---|---|---|---|---|---|---|---|---|---|
| | | 0 | 1 | 2 | 3 | 4 | 5 | 6 | 7 | 8 | 9 |
| Location | 0 | −1 | −6 | 0 | −16 | 3 | 45 | 2 | −15 | 0 | −6 |
| of | 1 | −1 | −5 | 0 | −16 | 5 | 45 | 0 | −15 | 0 | −6 |
| Inter- | 2 | −1 | −5 | 0 | −17 | 7 | 44 | −1 | −14 | 0 | −6 |
| polation | 3 | −2 | −5 | 0 | −17 | 9 | 44 | −3 | −13 | 0 | −6 |
| | 4 | −2 | −5 | 0 | −17 | 11 | 44 | −5 | −13 | 0 | −6 |
| | 5 | −2 | −5 | −1 | −18 | 12 | 43 | −6 | −12 | 0 | −6 |
| | 6 | −2 | −5 | −1 | −18 | 14 | 42 | −7 | −11 | 0 | −6 |
| | 7 | −3 | −4 | −1 | −18 | 16 | 41 | −9 | −11 | 0 | −6 |
| | 8 | −3 | −4 | −1 | −18 | 18 | 41 | −10 | −10 | −1 | −5 |
| | 9 | −3 | −4 | −2 | −18 | 20 | 40 | −11 | −9 | −1 | −5 |
| | 10 | −3 | −4 | −2 | −18 | 22 | 38 | −12 | −9 | −1 | −5 |
| | 11 | −3 | −4 | −3 | −18 | 23 | 37 | −13 | −8 | −1 | −5 |
| | 12 | −4 | −3 | −3 | −18 | 25 | 36 | −14 | −7 | −1 | −5 |
| | 13 | −4 | −3 | −4 | −17 | 27 | 35 | −15 | −7 | −2 | −5 |
| | 14 | −4 | −3 | −4 | −17 | 29 | 33 | −15 | −6 | −2 | −5 |
| | 15 | −4 | −3 | −5 | −17 | 30 | 32 | −16 | −5 | −2 | −4 |
| | 16 | −4 | −2 | −5 | −16 | 32 | 30 | −17 | −5 | −3 | −4 |
| | 17 | −5 | −2 | −6 | −15 | 33 | 29 | −17 | −4 | −3 | −4 |
| | 18 | −5 | −2 | −7 | −15 | 35 | 27 | −17 | −4 | −3 | −4 |
| | 19 | −5 | −1 | −7 | −14 | 36 | 25 | −18 | −3 | −3 | −4 |
| | 20 | −5 | −1 | −8 | −13 | 37 | 23 | −18 | −3 | −4 | −3 |
| | 21 | −5 | −1 | −9 | −12 | 38 | 22 | −18 | −2 | −4 | −3 |
| | 22 | −5 | −1 | −9 | −11 | 40 | 20 | −18 | −2 | −4 | −3 |
| | 23 | −5 | −1 | −10 | −10 | 41 | 18 | −18 | −1 | −4 | −3 |
| | 24 | −6 | 0 | −11 | −9 | 41 | 16 | −18 | −1 | −4 | −3 |
| | 25 | −6 | 0 | −11 | −7 | 42 | 14 | −18 | −1 | −5 | −2 |
| | 26 | −6 | 0 | −12 | −6 | 43 | 12 | −18 | −1 | −5 | −2 |
| | 27 | −6 | 0 | −13 | −5 | 44 | 11 | −17 | 0 | −5 | −2 |
| | 28 | −6 | 0 | −13 | −3 | 44 | 9 | −17 | 0 | −5 | −2 |
| | 29 | −6 | 0 | −14 | −1 | 44 | 7 | −17 | 0 | −5 | −1 |
| | 30 | −6 | 0 | −15 | 0 | 45 | 5 | −16 | 0 | −5 | −1 |
| | 31 | −6 | 0 | −15 | 2 | 45 | 3 | −16 | 0 | −6 | −1 |

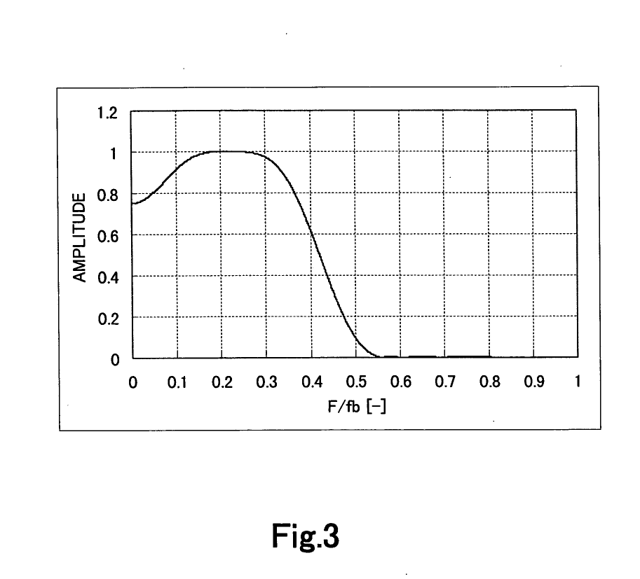

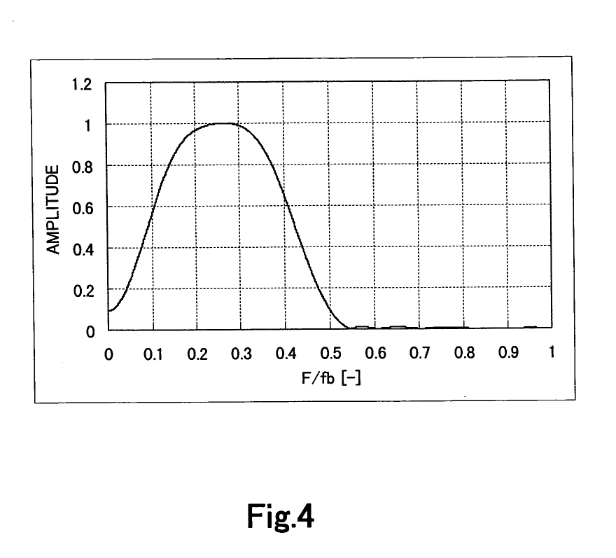

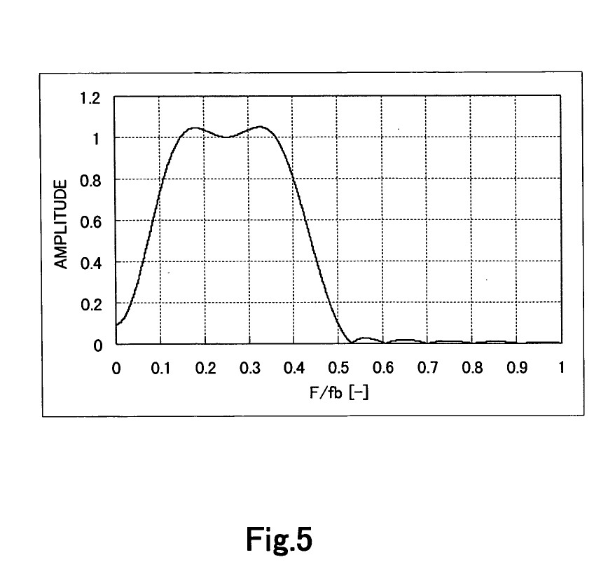

Further, frequency characteristics of a signal processed using the tap coefficients shown in Tables 1, 2, and 3 are plotted in graphs shown in FIGS. 3, 4, and 5, respectively.

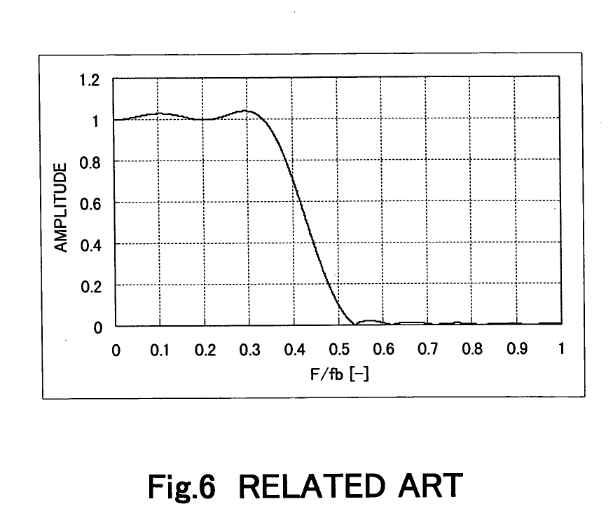

On the other hand, sample values set to tap coefficients for a related art interpolator having the LPF capability are listed in Table 4, and frequency characteristics of a signal processed using the tap coefficients listed in Table 4 are plotted in a graph of FIG. 6.

TABLE 4

| | | Tap Number | | | | | | | | | |
|---|---|---|---|---|---|---|---|---|---|---|---|
| | | 0 | 1 | 2 | 3 | 4 | 5 | 6 | 7 | 8 | 9 |
| Location of | 0 | 0 | −1 | 5 | −9 | 12 | 52 | 11 | −8 | 5 | −2 |
| Interpolation | 1 | 0 | −1 | 4 | −9 | 14 | 52 | 9 | −8 | 5 | −2 |
| | 2 | 0 | −1 | 4 | −9 | 16 | 52 | 8 | −7 | 5 | −2 |
| | 3 | 0 | −1 | 4 | −9 | 18 | 51 | 6 | −7 | 4 | −2 |
| | 4 | 0 | −1 | 4 | −10 | 19 | 51 | 5 | −6 | 4 | −2 |
| | 5 | −1 | −1 | 4 | −10 | 21 | 50 | 3 | −6 | 4 | −2 |
| | 6 | −1 | 0 | 4 | −10 | 23 | 50 | 2 | −5 | 4 | −2 |
| | 7 | −1 | 0 | 3 | −10 | 25 | 49 | 1 | −5 | 4 | −2 |
| | 8 | −1 | 0 | 3 | −10 | 27 | 48 | −1 | −4 | 4 | −2 |
| | 9 | −1 | 0 | 3 | −10 | 28 | 47 | −2 | −4 | 4 | −2 |
| | 10 | −1 | 1 | 2 | −10 | 30 | 46 | −3 | −3 | 3 | −2 |
| | 11 | −1 | 1 | 2 | −9 | 32 | 45 | −4 | −2 | 3 | −2 |
| | 12 | −1 | 1 | 2 | −9 | 33 | 44 | −5 | −2 | 3 | −2 |
| | 13 | −1 | 1 | 1 | −9 | 35 | 42 | −6 | −1 | 3 | −2 |
| | 14 | −2 | 2 | 1 | −8 | 37 | 41 | −6 | −1 | 2 | −2 |
| | 15 | −2 | 2 | 0 | −8 | 38 | 40 | −7 | 0 | 2 | −2 |
| | 16 | −2 | 2 | 0 | −7 | 40 | 38 | −8 | 0 | 2 | −2 |
| | 17 | −2 | 2 | −1 | −6 | 41 | 37 | −8 | 1 | 2 | −2 |
| | 18 | −2 | 3 | −1 | −6 | 42 | 35 | −9 | 1 | 1 | −1 |
| | 19 | −2 | 3 | −2 | −5 | 44 | 33 | −9 | 2 | 1 | −1 |
| | 20 | −2 | 3 | −2 | −4 | 45 | 32 | −9 | 2 | 1 | −1 |
| | 21 | −2 | 3 | −3 | −3 | 46 | 30 | −10 | 2 | 1 | −1 |
| | 22 | −2 | 4 | −4 | −2 | 47 | 28 | −10 | 3 | 0 | −1 |
| | 23 | −2 | 4 | −4 | −1 | 48 | 27 | −10 | 3 | 0 | −1 |
| | 24 | −2 | 4 | −5 | 1 | 49 | 25 | −10 | 3 | 0 | −1 |
| | 25 | −2 | 4 | −5 | 2 | 50 | 23 | −10 | 4 | 0 | −1 |
| | 26 | −2 | 4 | −6 | 3 | 50 | 21 | −10 | 4 | −1 | −1 |
| | 27 | −2 | 4 | −6 | 5 | 51 | 19 | −10 | 4 | −1 | 0 |
| | 28 | −2 | 4 | −7 | 6 | 51 | 18 | −9 | 4 | −1 | 0 |
| | 29 | −2 | 5 | −7 | 8 | 52 | 16 | −9 | 4 | −1 | 0 |
| | 30 | −2 | 5 | −8 | 9 | 52 | 14 | −9 | 4 | −1 | 0 |
| | 31 | −2 | 5 | −8 | 11 | 52 | 12 | −9 | 5 | −1 | 0 |

Referring back to FIG. 1, the output data sample Y output from the interpolator 100 is filtered through an equalizer 280 which includes a filter 282, consisting of at least one of a fix filter, bandpass filter (BPF)/highpass filter (HPF), all pass filter, or the like, a FIR filter 284, and others, and the output data sample Y is then output as data Z.

A location to be estimated and interpolated by the interpolator 100 is determined by controlling the interpolator 100 through the use of a feedback loop 300 including, for example, a bit estimation point error detector 320, a loop filter 340, and a controller 360 (numerical controlled oscillator (NCO)). The bit estimation point error detector 320 detects a timing error in the output data Z, and the loop filter 340 removes a noise component from the detected timing error and then performs integral, differential, and other evaluations on the resultant timing error. The controller 360 feeds back the timing error processed by the loop filter 340 to the interpolator 100 to control operation of the interpolator 100. All looping operations corresponding to operation of the phase locked loop (PLL) for bit point synchronization can be executed by digital processing. In the feedback loop 300, deviation with respect to symmetry properties is detected from, for example, an absolute value of sampled data to execute feedback for making the error zero.

There is no specific limitation to a signal to be processed by the interpolator according to this embodiment as long as the signal is a digital signal. The interpolator is extremely effective, in particular, at processing a signal, such as a PR4 signal, PR5 signal, dicode code, mirror-squared (M2) code, phase encoding (PE) code, etc., which is used in a digital system, such as, for example, a digital video camera (DVC), and which includes no direct-current component in necessary signal components.

The interpolator according to this embodiment may be configured to be a digital integrated circuit, such as a CMOS-LSI, or a digital/analog integrated circuit for use as a digital signal processing circuit in a signal processing apparatus used in terrestrial digital broadcasting, satellite digital broadcasting, a digital video, digital communication, a CD system, an MD system, a DVD system or the like.

By using the interpolator of this embodiment, a DC offset component can be removed without provision of a circuit, such as a coupling condenser, a DC offset cancellation circuit, or the like.

1. An interpolator for interpolating a digital signal obtained by digitally sampling an analog signal, comprising:
a register which receives the digital signal at a plurality of taps and generates tap outputs from a plurality of the taps;
a multiplier which multiplies each of the tap outputs by a coefficient defined to impart a capability of a bandpass filter which passes a signal in a predetermined frequency range to the tap outputs, and
an adder which sums outputs from the multiplier.

2. An interpolator according to claim 1, wherein the coefficient is variable.

3. An interpolator according to claim 1, wherein the digital signal includes no direct-current component.

4. An interpolator according to claim 2, wherein the digital signal includes no direct-current component.

5. An interpolation method for interpolating a digital signal obtained by digitally sampling an analog signal, comprising:
receiving the digital signal at a plurality of taps and generating tap outputs from a plurality of the taps;
multiplying each of the tap outputs by a coefficient defined to impart a capability of a bandpass filter which passes a signal in a predetermined frequency range to the tap outputs, and
summing the multiplied outputs.

6. A signal processing circuit comprising:
an interpolator for interpolating a digital signal obtained by digitally sampling an analog signal, the interpolator including:
a register which receives the digital signal at a plurality of taps and generates tap outputs from a plurality of the taps;
a multiplier which multiplies each of the tap outputs by a coefficient defined to impart a capability of a bandpass filter which passes a signal in a predetermined frequency range to the tap outputs, and
an adder which sums outputs from the multiplier.

7. A signal processing circuit according to claim 6, wherein the coefficient is variable.

8. A signal processing circuit according to claim 6, wherein the digital signal includes no direct-current component.

9. A signal processing circuit according to claim 6, further comprising a controller to control a location where bit points are interpolated by the interpolator.

10. A signal processing circuit according to claim 9, further comprising a detector which detects a timing error in a signal output from the interpolator, wherein
the controller executes a control operation based on the timing error detected.
